(19) United States
(12) Patent Application Publication
(10) Pub. No.: US 2013/0050245 A1
(43) Pub. Date: Feb. 28, 2013

(54) Gamut Compression for Video Display Devices

(71) Applicants: Peter W. Longhurst, Vancouver (CA); Robert O'Dwyer, Vancouver (CA); Gregory J. Ward, Berkeley, CA (US); Lewis Johnson, Delta (CA)

(72) Inventors: Peter W. Longhurst, Vancouver (CA); Robert O'Dwyer, Vancouver (CA); Gregory J. Ward, Berkeley, CA (US); Lewis Johnson, Delta (CA)

(73) Assignee: DOLBY LABORATORIES LICENSING CORPORATION, San Francisco, CA (US)

(21) Appl. No.: 13/641,776

(22) PCT Filed: May 9, 2011
(86) PCT No.: PCT/US11/35766

§ 371 Date: Oct. 17, 2012

Related U.S. Application Data
(60) Provisional application No. 61/334,249, filed on May 13, 2010.

(51) Int. Cl. G09G 5/02

(52) U.S. Cl. 345/590

(57) ABSTRACT

Apparatus and methods are provided to map out-of-gamut points to in-gamut points. Embodiments transform image data for presentation on a display or medium having a gamut different from that of the image data. Different mapping algorithms may be applied based in part on luminance of the points being mapped. Embodiments apply a reduced dataset representing a gamut boundary. Irregular gamuts may be accommodated

### CROSS REFERENCE TO RELATED APPLICATIONS

This application claims priority to U.S. Provisional Patent Application No. 61/334,249 filed 13 May 2010, hereby incorporated by reference in its entirety.

### TECHNICAL FIELD

The invention relates to the processing and display of images. The invention has specific application to color images. Aspects of the invention provide apparatus and methods for adjusting image data for display on displays of specific types

### BACKGROUND

Displays include televisions, computer monitors, home cinema displays, digital cinema displays, dedicated displays on devices such as tablet computers, cellular telephones, digital cameras, copiers, industrial controls, specialized displays such as displays for medical imaging, virtual reality, vehicle simulation and the like. Color displays may be used to display color images specified by image data.

Displays may incorporate any of a wide variety of underlying display technologies. For example, displays may comprise: cathode ray tube (CRT) displays; backlit liquid crystal displays (LCDs); plasma displays; organic LED displays (OLED displays); laser projectors; digital minor device (DMD) displays; and electroluminescent displays. Within any of these general technologies a wide variety of different constructions and compositions for light-emitting and/or filtering elements are possible. As a result, different displays may have capabilities that differ significantly in areas such as: the range of different colors (gamut) that can be displayed; the available dynamic range; the white point and the like.

Image data (including video data and still image data) can have any of a wide variety of different formats. Some example image formats are: RGB, YUV, GIF, TIFF, JPEG/JIF, PNG, BMP, PDF, RAW, FITS, MPEG, MP4, high dynamic range (HDR) formats such as BEF, HDRi, JPEG XR, JPEG HDR, RGBE, ScRGB and many others. Image formats can have capabilities that differ significantly in areas such as: the gamut (range of colors) that can be specified, the range of luminance that can be specified, the number of discrete colors within the gamut that can be specified, the number of discrete luminance levels that can be specified and the like. Some image formats have multiple versions having different capabilities.

Images may be displayed on media other than displays. For example, images may be printed. Such other media may also differ from image data and from one another in achievable imaging characteristics.

Colors may be specified in many different color spaces. Some examples include RGB, HSV, LUV, YCbCr, YIQ, YCbCr, xvYCC, HSL, XYZ, CMYK, CIE LAB, IPT, and others. Different image data formats may specify colors in different color spaces.

It may be desirable to display image data on a display that has a gamut that is too limited to display the full range of colors and/or luminance specified in the image data. There is a need for apparatus and methods capable of adjusting image data to provide a good viewing experience even in cases where there is a mismatch between the image specification characteristics of image data and image reproduction characteristics of a display or other medium on which the image will be reproduced.

### SUMMARY OF THE INVENTION

The invention has a number of different aspects. These include, without limitation: color displays; apparatus for transmitting and/or processing image data; methods for altering image data to take into account capabilities of displays on which the image data will be displayed; methods for driving displays to reproduce image data which includes specification of out-of-gamut colors; methods for converting video data between formats and the like.

Further aspects of the invention and features of specific embodiments of the invention are described below.

### BRIEF DESCRIPTION OF THE DRAWINGS

The accompanying drawings illustrate non-limiting embodiments of the invention.

FIG. 1 is a schematic representation of a color space with longitudinal and latitudinal lines demarcating the boundaries of a gamut.

FIG. 2 is a flow chart which illustrates a method that may be applied to adjust image data that includes out-of-gamut pixels.

FIGS. 2A and 2B are slices through an out-of-gamut pixel (color point) and color gamut respectively in the plane of a longitudinal line passing through the pixel and the plane of a latitudinal line passing through the pixel.

FIGS. 3A, 3B, 3C and 3D illustrate example ways in which areas of a half-plane (segment) in which out-of-gamut points may be located may be sectioned.

FIG. 4 illustrates compression as it may be applied in an example embodiment.

FIG. 4A illustrates some possibilities for the types of compression that may be applied.

FIG. 4B is a section through a color gamut showing a region into which out-of-gamut points may be compressed that is of non-uniform thickness.

FIGS. 5, 5A and 5B show example ways that a segment may be subdivided into sections.

FIG. 6A through 6B are schematic illustrations showing intermediate steps in the subdivision of a segment into sections in an example embodiment.

FIG. 7 is a schematic illustration of a data structure representing a gamut boundary.

FIG. 8 is a flow chart illustrating an example mapping method for mapping out-of-gamut points to in-gamut points.

FIG. 9 illustrates one approach that may be applied to determining an in-gamut location to which to transform an out-of-gamut point.

FIG. 10 shows a latitudinal plane through an example gamut and illustrates a variation in the gamut boundary between segments.

FIG. 10A is a flow chart illustrating a method which applies interpolation between distances determined for two adjacent segments to establish a mapping for a point.

FIG. 11 is a block diagram of an example gamut compression apparatus

FIG. 12 illustrates a possible set of configuration information for use in gamut mapping according to some example embodiments.

FIG. 13 is a flow chart illustrating a method that may be applied to real-time gamut mapping of image data.

FIG. 14 shows a cross section in color space of a gamut in which a grey line is both curved and translated relative to an axis of the color space; and FIG. 14A shows a transformed version of the gamut of FIG. 14.

FIG. 14B illustrates the data flow in a gamut translation method wherein additional transformations are performed to accommodate an irregular gamut.

FIG. 15 is a flow chart illustrating an example mapping method for mapping out-of-gamut points to in-gamut points.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

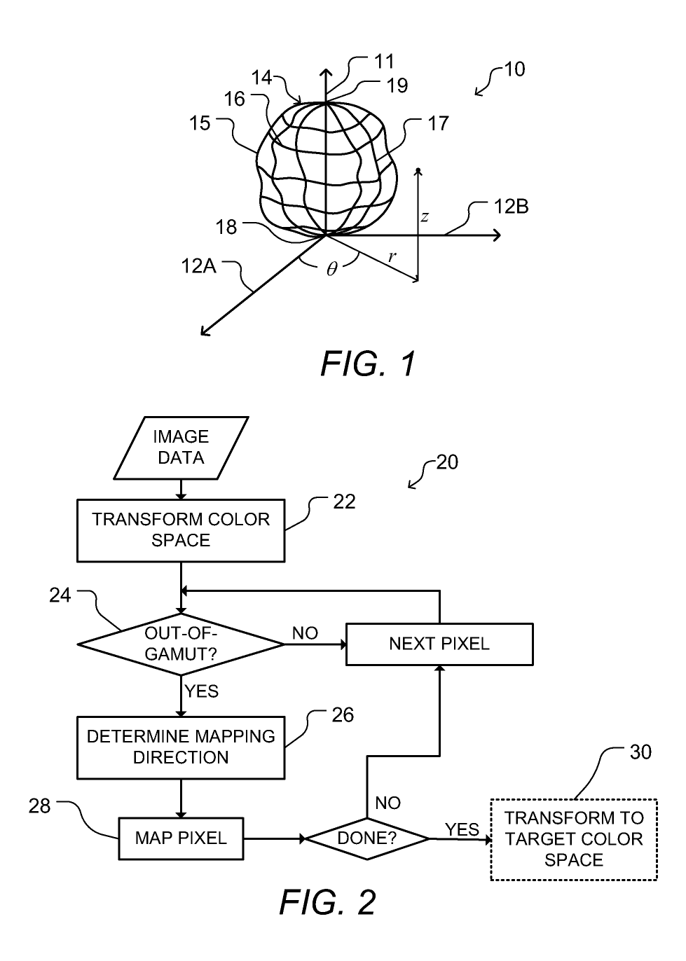

FIG. 1 shows an example color space 10 defined by a lightness axis 11 and two color-specifying axes 12A and 12B. Axes 12A and 12B define a plane perpendicular to lightness axis 11. A color gamut 14 has the form of a three-dimensional area in color space 10. A boundary 15 of gamut 14 is shown as being demarcated by longitudinal lines 17 and latitudinal lines 16. Gamut 14 has a black point 18 and a white point 19. In this embodiment, black point 18 and white point 19 are both on lightness axis 11. Gamut 14 may, for example, comprise a gamut of a particular display or another particular image reproduction process.

Advantageously, points in color space 10 may be defined by cylindrical coordinates. One coordinate z indicates a height of a point above the plane defined by axes 12A and 12B, a second coordinate r indicates a radial distance of the point from axis 11 and a third coordinate è indicates the angle around axis 11 at which the point is located. Any point in color space 10 may be identified by the triplet (r, è, z). In some color spaces such as color-opponent color spaces, r is a chroma coordinate which indicates how colorful the point is (saturation or intensity of color), z is a lightness coordinate indicating, for example, the perceived brightness of the point relative to a reference white, a luminance or the like, and è is a hue coordinate which identifies the color of the point (e.g. a specific red, blue, pink, orange, green, etc.).

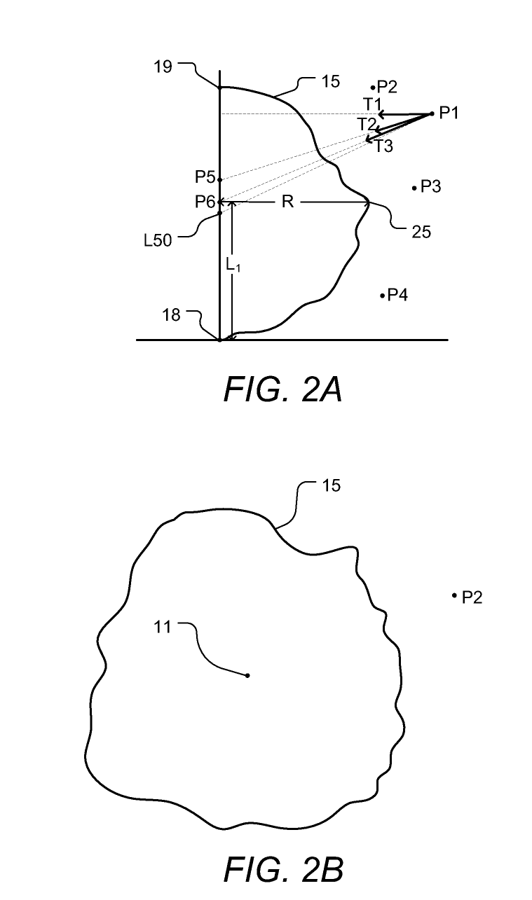

FIG. 2 illustrates a method 20 that may be applied to adjust image data that includes out-of-gamut pixels to provide adjusted image data in which colors for all pixels are in gamut 14 (points on boundary 15 may be considered to be in gamut 14). Each pixel can be represented by a point in color space 10. The same point in color space 10 may be associated with any number of pixels.

Method 20 optionally transforms image data from another color space to color space 10 in block 22. Image data may already be represented in color space 10 in which case block 22 is not required. In some embodiments, image data is initially represented in a first color space that is not a color-opponent color space and block 22 comprises transformation into a color-opponent color space.

The transformation applied to transform image data into color space 10 may involve a white point. For example, transformations into the CIELAB or IPT color spaces require that a white point be specified. In some cases, the white point for the image data may differ from that of an output device or medium. In such cases it is desirable that the white point of the device or medium is used as a white point for the transformation into color space 10.

In some cases it may be desirable that an image specified by the image data be displayed while preserving a white point associated with the image data. One option for handling such cases is to transform the gamut boundary for the target device or medium into color space 10 using the white point of the target device or medium, and transform the image data into color space 10 via an intermediate color space transformation. The intermediate color space may, for example, be an XYZ color space. The image data is transformed into the intermediate color space using the white point associated with the image data. The image data in the intermediate color space is then transformed into color space 10 using the white point of the destination device or medium. This procedure may be used, for example to transform RGB image data into an IPT or CIELAB color space.

Another option is to transform the gamut boundary for the target device or medium into color space 10 using the white point of the target device or medium and transform the image data into color space 10 via an intermediate color space. The image data is transformed into the intermediate color space using the white point associated with the image data. The intermediate color space may, for example, be an XYZ color space. A chromatic adaptation is performed on the image data in the intermediate color space and then such image data is transformed from the intermediate color space into color space 10 using the white point of the destination device or medium.

A Chromatic Adaptation Transform or CAT is a transform that translates the whitepoint of a signal. A CAT is commonly used to adjust colour balance. A CAT may be applied to remove/account for color cast introduced by a display. Applying a CAT may be useful to map colors intended for the source image data to a target device. CAT are described, for example, in: G. D. Finlayson and S. Süsstrunk, Spectral Sharpening and the Bradford Transform, Proc. Color Imaging Symposium (CIS 2000), pp. 236-243, 2000; G. D. Finlayson and S. Süsstrunk, Performance of a Chromatic Adaptation Transform Based on Spectral Sharpening, Proc. IS&T/SID 8th Color Imaging Conference, Vol. 8, pp. 49-55, 2000; S. Süsstrunk, J. Holm and G. D. Finlayson, Chromatic adaptation performance of different RGB sensors, Proc. IS&T/SPIE Electronic Imaging 2001: Color Imaging, Vol. 4300, pp. 172-183, 2001; G. Sharma (Ed.) Digital Color Imaging Handbook, CRC Press 2003 ISBN 0-8493-0900-X; all of which are hereby incorporated herein by reference. The CAT may comprise a Bradford CAT or linearized Bradford CAT or spectral sharpening transform or von Kries adaptation transform, for example.

Another option is to transform both the image data and the gamut boundary of the target device or medium into color space 10 using a predetermined white point, for example a D65 white point. Once in color space 10, a translation/rotation may be performed on both the transformed image data and the gamut boundary. The transformation/rotation is selected to shift a greyscale line of the gamut to coincide with axis 11 of color space 10. After gamut compression as described herein an inverse of the translation/rotation may be performed before transforming the resulting gamut-compressed data into a color space suitable for application to display an image on a target display or present the image on a target medium.

Blocks 24 through 28 of method 20 are performed for each pixel. Pixels may be processed in parallel or sequentially, in any order, or in some combination thereof. Block 24 determines whether a pixel is in-gamut or out-of-gamut. Block 24 may, for example, comprise comparing color coordinates for the pixel (e.g. coordinates referenced to axes 11, 12A and 12B of FIG. 1) to boundary data for gamut 14 of the target display or medium. If the pixel is in gamut 14 then no action is required in this embodiment. If the pixel is out-of-gamut, then in block 26 a mapping direction is determined for the pixel. A mapping direction may comprise a vector pointing toward a point on gamut boundary 15 to which the pixel will be mapped. The mapping direction may be a function of the luminance for the pixel. In block 28 the color coordinates for the pixel are projected in the mapping direction onto gamut boundary 15 (so that the color coordinates are adjusted to the point of intersection of the gamut boundary with a line in the mapping direction). The result of block 28 is gamut-compressed image data.

The mapping direction may be selected to preserve the hue of the pixel (i.e. such that a hue value before the block 28 adjustment is the same, at least to within some tolerance, as the hue value after the block 28 adjustment). In some embodiments, where color space 10 is a color-opponent color space, hue is preserved within the half-planes defined by axis 11 and a longitudinal line 17, and bounded along one edge by axis 11. In such embodiments, as long as the mapping direction lies in such a half plane, hue will be preserved. Achievable color spaces are not perfectly hue-preserving in longitudinal half-planes but can be acceptably close for many applications. The IPT and CIE LAB color spaces are examples of suitable color-opponent color spaces in which the methods described herein may be applied.

In optional block 30, gamut-compressed image data is transformed into a color space suitable for application in displaying an image on a target display or presenting an image on a target medium. Advantageously, points on axis 11 correspond to greyscale values for the target device or medium. In some embodiments, block 30 comprises two stages (which may optionally be executed using a combined mathematical operation). For example, the transformation of block 30 may be executed by performing a first transformation into an intermediate color space and a second transformation from the intermediate color space to a color space convenient for use in driving a target display and/or applying the gamut-compressed image to a target medium.

In some embodiments, an algorithm for choosing the mapping direction for a point is selected based at least in part on a luminance value for the point. For example, in some embodiments, the mapping direction is selected differently depending upon whether or not the pixel's z-coordinate (the position of the pixel along axis 11) is above or below a threshold value. The threshold value may itself be a function of one or both of the position of the pixel along color coordinates 12A and 12B. In some embodiments, the threshold value corresponds to or is a function of a location of a cusp in boundary 15 as described in more detail below.

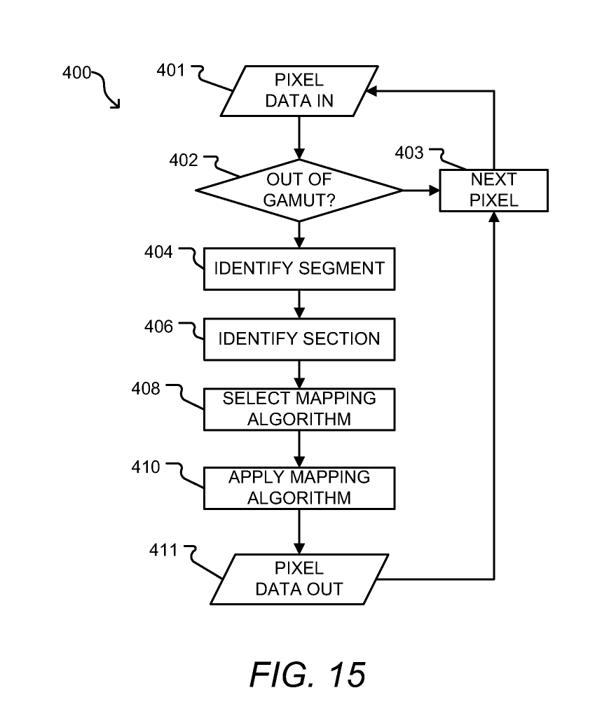

FIG. 15 illustrates a method 400 for mapping out-of-gamut points to in-gamut points. Method 400 receives incoming pixel data 401 for a point. If the point is determined to be out-of-gamut at block 402, method 400 identifies at block 404 the segment (e.g. a surface having constant hue in the color space) on which the point is located. The segment may be divided into sections such as wedge-shaped sections. At block 406, method 400 identifies the section of the segment at which the point is located. At block 408, a mapping algorithm is selected for mapping the out-of-gamut point to a location in the color space which is in-gamut. The mapping algorithm may be selected based at least in part on the section in which the point is located, or some other factor(s). For example, a particular mapping algorithm may be associated with each section of the segment. At block 410, the mapping algorithm selected at block 408 is applied to map the out-of-gamut point to a corresponding in-gamut point, resulting in gamut-compressed pixel data 411. Method 400 repeats after retrieving pixel data for the next pixel at block 403.

FIGS. 2A and 2B, respectively, are slices through an out-of-gamut pixel and color gamut 14 in the plane of a longitudinal line passing through the pixel (FIG. 2A) and the plane of a latitudinal line passing through the pixel (FIG. 2B). The plane shown in FIG. 2A may be called a longitudinal plane. The plane shown in FIG. 2B may be called a transverse plane. Axis 11 and a portion of boundary 15 can be seen in each of FIGS. 2A and 2B. Where color space 10 is a color-opponent color space, hue is preserved by transformations which take a point in the plane of FIG. 2A to another point in the plane of FIG. 2A or, more generally, transformations which take a point in a longitudinal half-plane to another point in the same longitudinal half-plane or transformations which preserve the value of the è coordinate. Such transformations involve mapping directions that are directed toward (e.g. intersect with) axis 11.

FIG. 2A illustrates a case wherein boundary 15 exhibits a cusp 25 between white point 19 and black point 18. The presence of cusps 25 is typical of the gamuts of most displays and other media. Cusp 25 is a point on boundary 15 in a longitudinal half-plane that is farthest from axis 11. The location of cusp 25 along axis 11 (indicated as L1 in FIG. 2A) and the distance of cusp 25 from axis 11 (indicated as R in FIG. 2A) may differ for different longitudinal half-planes.

FIG. 2A shows a number of out-of-gamut points P1, P2, P3 and P4. Point P2 is also shown in FIG. 2B. Some example hue-preserving mapping directions T1, T2, T3 are shown for P1. T1 takes P1 toward a point on boundary 15 having the same value along axis 11 as does P1. T1 may be called a constant luminance transformation. T2 takes P1 toward a specific point P5 on axis 11. Point P5 may comprise, for example a global center point. T3 takes P1 toward a different specific point P6 on axis 11. In the illustrated embodiment, point P6 has the same luminance as cusp 25. Cusp 25 may be identified as the point in a segment on boundary 15 that is farthest from axis 11. Where a device gamut has a boundary section in a segment in which points in the section are of equal maximum chroma then a midpoint of the section may be identified as the cusp.

In some embodiments, a mapping direction for at least some points may be in a direction toward a point that is not on axis 11. In some embodiments, the mapping direction for at least some points is toward a focus point that is on a far side of axis 11 from the point being mapped.

Some embodiments apply different algorithms for determining mapping directions depending at least in part upon the distance of an out-of-gamut point along axis 11 (the “lightness” of the point in some embodiments). For example, the mapping direction may be determined according to a first algorithm for points below cusp 25 (e.g. points having values of lightness less than L1) and a second algorithm for points above cusp 25 (e.g. points having values of lightness greater than L1). In some embodiments, mapping directions are selected in one way for points above cusp 25 and in another way for points below cusp 25. In some embodiments points above a line are mapped according to a first algorithm while points below the line are mapped according to a second algorithm different from the first algorithm.

For example, where an out-of-gamut point is lower than the corresponding cusp 25, the mapping direction may be chosen to lie in the same transverse plane as the point being mapped (e.g. keeping lightness constant). In the same example, where the out-of-gamut point is higher than the corresponding cusp 25 the mapping direction may be chosen differently, for example mapping toward a fixed point on axis 11. The fixed point may be chosen in various ways, such as, for example: a mapping direction toward a point that is half-way between white point 19 and black point 18 (indicated as having the value L50 in FIG. 2A); a mapping direction toward the location of cusp 25 along axis 11 (e.g. the point on axis 11 having the value P6 in FIG. 2A); etc.

Other algorithms may be applied for determining a mapping direction. Some examples are: algorithms that choose a direction toward the closest point on boundary 15 having the same hue as the point being transformed; etc.

In some embodiments it can be desirable to provide optional false-color algorithms. For example, instead of mapping out-of-gamut points to points on the gamut boundary that are in some sense ‘closest’ to the out-of-gamut points, one could map out-of-gamut points to a reserved color or to in-gamut colors that are far from (even furthest from) the point. In some embodiments out-of-gamut points are mapped to corresponding points that are on the gamut boundary on a far side of axis 11 from the out-of gamut point. In some embodiments the corresponding points are located on the gamut boundary on a line passing through the out-of-gamut point and axis 11. Such a mapping will make out-of-gamut points stand out in contrast to surrounding in-gamut points. Such false color mapping may be useful to assist a colorist or other professional to study the areas of an image that have out-of-gamut points.

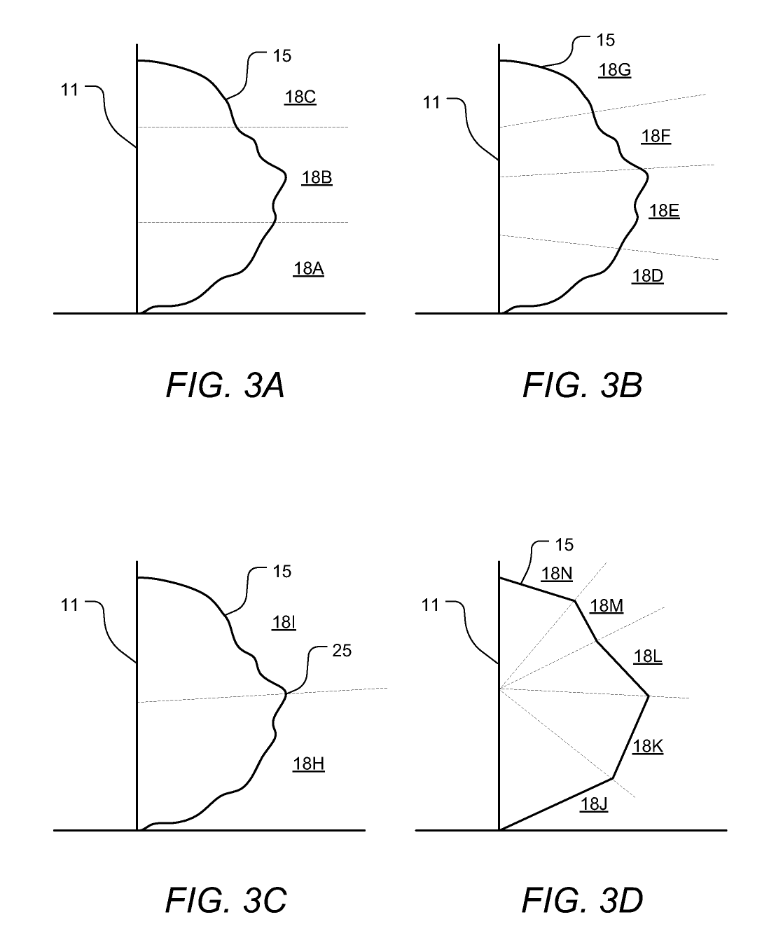

In some embodiments, the choice of algorithm applied to determine a mapping direction for out-of-gamut points depends on the location of the points. In some such embodiments, longitudinal planes in which out-of-gamut points may be located are divided into sections and each section is associated with a corresponding algorithm for determining mapping directions for out-of-gamut points falling within the section. FIGS. 3A, 3B, 3C and 3D illustrate example ways in which areas of a half-plane in which out-of-gamut points may be located may be sectioned. In some embodiments, locations of section boundaries are determined at least in part based on the locations of features of boundary 15 lying in the half-plane. For example, section boundaries may be located based on locations of one or more of white point 19, black point 18, cusp 25, sections of boundary 15 approximated by linear segments of a piecewise linear curve, or the like. In some embodiments, the mapping algorithm used to map a point is selected based on a coordinate value of the point along axis 11 (e.g. a lightness value for the pixel).

FIG. 3A shows sections 18A, 18B and 18C defined between transverse planes (e.g. the section boundaries have constant values on axis 11). FIG. 3B shows sections 18D through 18G defined between lines passing through points on axis 11 and extending away from axis 11 at defined angles. FIG. 3C shows two sections 18H and 18I delineated by a boundary passing through both a point on axis 11 and cusp 25. FIG. 3D shows sections 18J through 18N delineated by boundaries which pass through endpoints of piecewise linear segments that define boundary 15. It can be appreciated that the number of sections in a half-plane may be varied.

In the embodiments described above, out-of-gamut points are clipped to boundary 15 by translating the out-of-gamut points to a point where a mapping trajectory intersects boundary 15. In other embodiments some or all out-of-gamut points are compressed into a region within gamut 14 and adjacent to boundary 15. In such embodiments, points that are farther out-of-gamut may be mapped to locations on or closer to boundary 15 whereas points that are not so far out-of-gamut may be mapped to points farther into the interior of gamut 14.

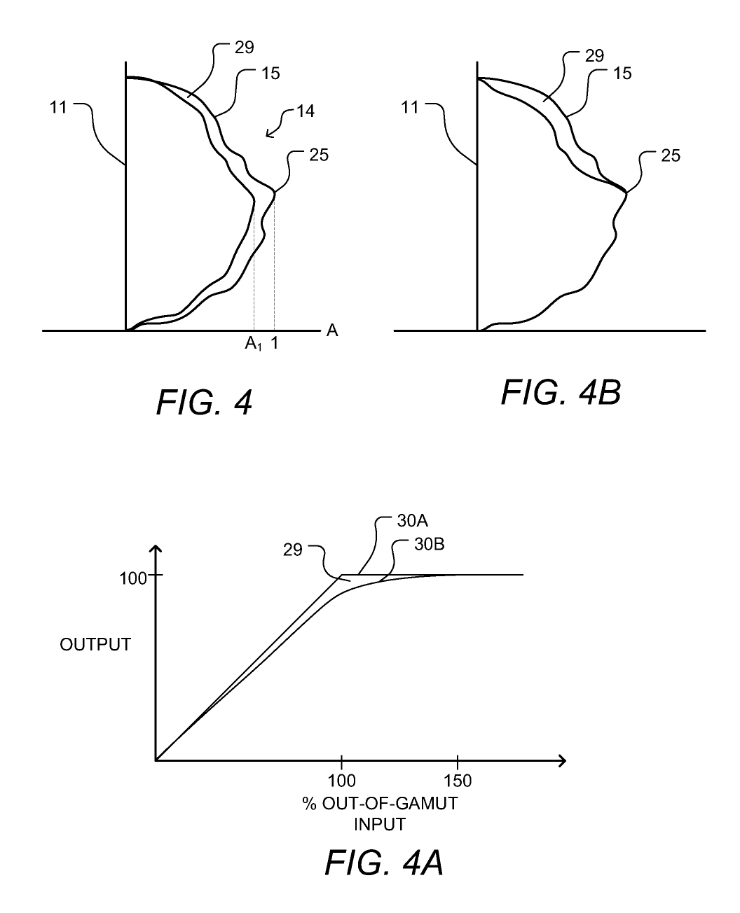

FIG. 4 illustrates compression as it may be applied in an example embodiment. Out-of-gamut points are mapped into a region 29 that is interior to gamut 14 adjacent to boundary 15. In-gamut points within region 29 are also mapped inwardly in gamut 14 to leave room for the out-of-gamut points. In an embodiment, mapping trajectories are determined for out-of-gamut points and each out-of-gamut point is mapped to a corresponding point along the mapping trajectory that is determined based at least in part on a measure of how much out-of-gamut the point is (the distance of the out-of-gamut point from boundary 15). In-gamut points that are close to boundary 15 are mapped along the mapping trajectory to corresponding points that are determined based at least in part on a measure of how close the in-gamut points are to boundary 15 (the distance of the in-gamut points to boundary 15).

FIG. 4 illustrates some possibilities for the types of compression that may be applied. The horizontal axis represents a normalized distance along a mapping trajectory as measured by a parameter A having the value of 1 at the intersection of the mapping trajectory with boundary 15. Points located in the interior of gamut 14 (i.e. points for which A A1<1) are mapped to themselves. Points having values of A that are in the range A1<A 1 are mapped toward the interior of gamut 14 to make room for at least some out-of-gamut points inside boundary 15. Points for which A>1 are mapped into outer portions of region 29. In some embodiments, all points on a trajectory that are out-of-gamut by more than some threshold amount are mapped to a point on boundary 15.

In FIG. 4A, curve 30A illustrates an example of a case where all out-of gamut points are mapped to corresponding points on boundary 15; curve 30B illustrates an example of a case where points that are far out of gamut are mapped to boundary 15, closer out-of-gamut points are mapped to a region inside boundary 15, and some in-gamut points that are near boundary 15 are compressed inwardly in color space 10 to make room for the closer out-of-gamut points.

In the embodiment illustrated in FIG. 4A, region 29 has a non-uniform thickness. In some embodiments, including the illustrated embodiment, region 29 tapers to zero thickness at white point 19 and/or black point 18. In the illustrated embodiment, region 29 tapers to zero thickness at both white point 19 and black point 18. In some embodiments, region 29 may have a thickness that is a function of the distance of boundary 15 from axis 11. For example, in some embodiments region 29 has a thickness that is a fixed proportion of the distance between boundary 15 and axis 11. In other embodiments, a thickness of region 29 is a function of position along axis 11 (with the thickness going to zero at positions corresponding to black point 18 and white point 19. In some such embodiments, mappings include a component that is a function of intensity.

In one embodiment a main mapping table such as lookup Table I described below specifies a mapping for points on a reference line between a global center point and a cusp of the gamut boundary. A separate mapping table may be provided for the black and white points. The separate mapping table may, for example, provide that all out of gamut points are clipped to the gamut boundary. This is reasonable to do because typical gamuts have no volume at the black and white points. For points not on axis 11 or the reference line, specific mapping tables may be determined by interpolating between the main mapping table and the separate mapping table. The interpolation may be based upon the position (e.g the angular position of the point between axis 11 and the reference line). A similar result may be achieved using an algorithm that varies the mapping of a point based on its position.

In some embodiments, points below a threshold lightness value (e.g. below cusp 25 or below a 50% lightness value or below some other specified threshold) are clipped to boundary 15 whereas points having a lightness value above the threshold are mapped into gamut 14 using an algorithm that provides compression of some points in gamut 14. In some embodiments a region 29 tapers to zero at a location on boundary 15 corresponding to the threshold. An example of such an embodiment is illustrated in FIG. 4B.

Gamut and tone mapping methods as described herein may be implemented using a programmed data processor (such as one or more microprocessors, graphics processors, digital signal processors, or the like) and/or specialized hardware (such as one or more suitably configured field programmable gate arrays (FPGAs), application specific integrated circuits (ASICs), logic pipelines, or the like. An issue in commercial applications is that image processing can be undesirably slow, especially where the images are video images, and can consume undesirably large amounts of computing resources and/or can require undesirably expensive hardware for a desired level of performance. Some example embodiments incorporate features that facilitate efficient gamut and tone mapping that may be implemented with relatively simple hardware and/or reduced computational resources.

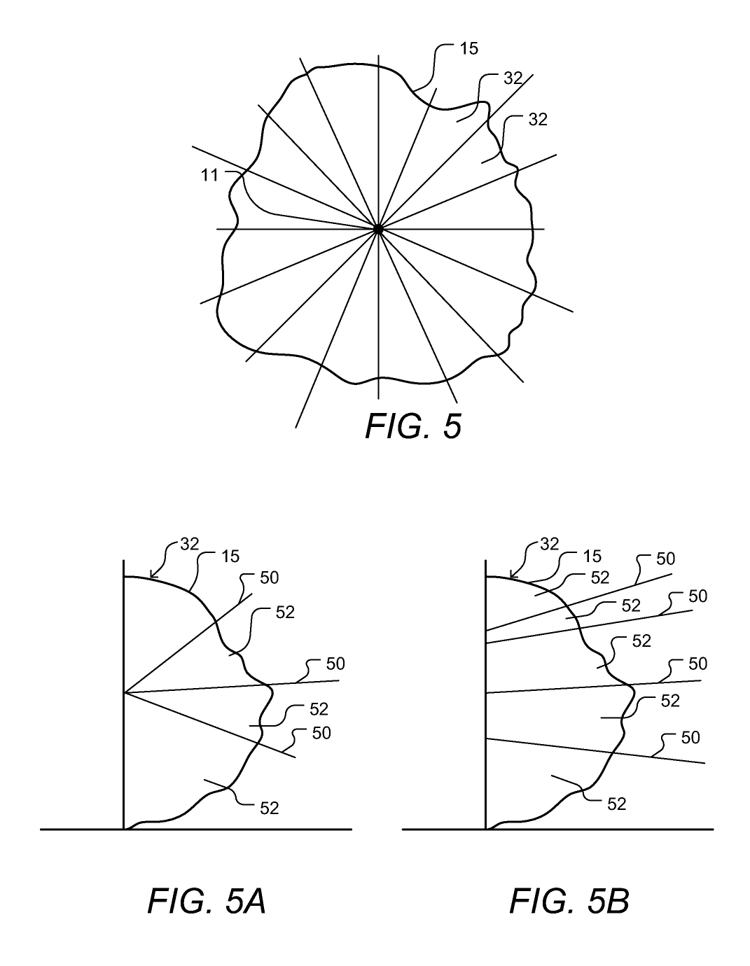

Determining whether or not a point falls outside of gamut 14 can be computationally- and memory-intensive since boundary 15 may be made up of a very large number of discrete points. Some embodiments represent boundary 15 by a reduced data set. FIG. 5 illustrates an approach taken in some such embodiments. Gamut 14 is divided into segments 32. Each segment 32 spans a few degrees of the circumference of gamut 14. In the illustrated embodiment, each segment 32 is wedge-shaped and the inner edge of the segment lies along axis 11. The number of segments 32 may be varied. In some embodiments, gamut 14 is divided into a number of segments in the range of 30 segments to 720 segments. Segments 32 are preferably thin enough at boundary 15 that the distance of boundary 15 from axis 11 is nearly constant across the thickness of the segment.

Segments 32 may be termed “hue segments” as hue is the same or nearly the same for all points within each segment 32.

Within each segment, boundary 15 may be approximated by a piecewise function. In preferred embodiments, the piecewise function is a piecewise-linear function. For example, each segment may be divided into a number of sections. It is convenient for each segment to be divided into a number of sections that is a power of two. For example, in some embodiments, each segment is divided into between 16 and 128 sections.

In example embodiments, boundaries between adjacent sections are straight lines that intersect with axis 11. FIGS. 5A and 5B show examples of ways that a segment may be subdivided into sections. In FIG. 5A all section boundaries intersect at a common point. In FIG. 5B, the section boundaries do not all intersect at a common point. The section boundaries are arranged so that every out-of-gamut point is associated with only one section.

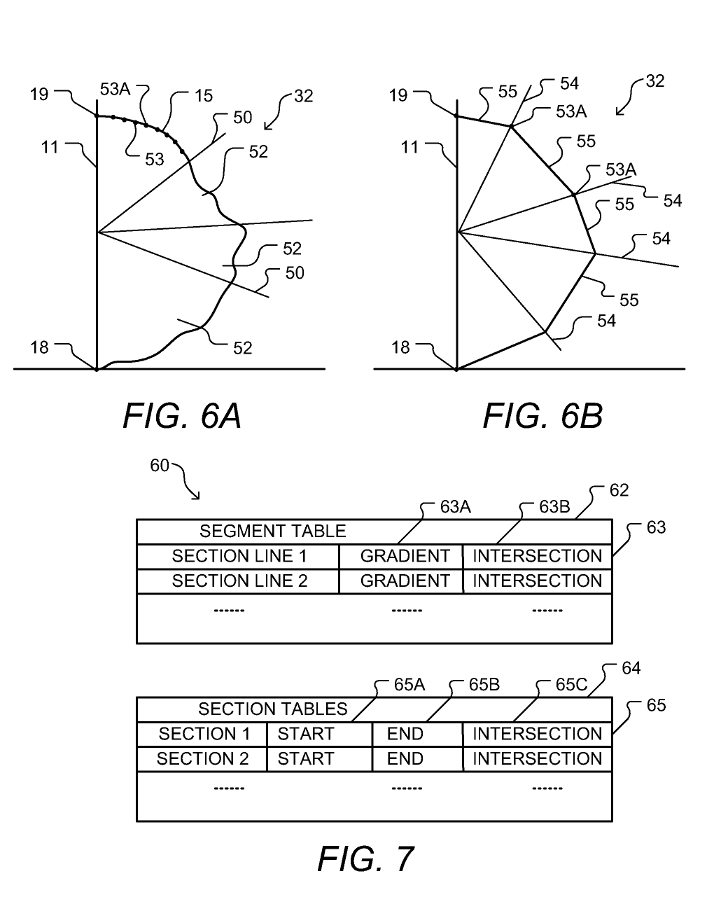

One example method for dividing a segment into sections is illustrated in FIGS. 6A and 6B. In FIG. 6A, a segment 32 is divided into a number of sections 52 along predetermined section lines 50. Each section 52 contains a number of points 53 on gamut boundary 15. The points 53 in each section are combined, for example by averaging, to yield a single representative point 53A in each section 52.

Black point 18 and white point 19 are established on axis 11 by locating the points on boundary 15 having respectively the smallest and largest luminances in each segment and then interpolating. In many cases these points will already lie on axis 11. For cases where they do not, one can determine an axis crossing point by, for example, averaging the luminance values for the black (minimum luminance) or white (maximum luminance) points. In some embodiments a weighted average is taken to identify the axis crossing point. For example, weights for each black or whit point may be determined by summing the distances that the points are away from luminance axis 11 and weighting the luminance value for each point by the distance that the point is away from axis 11 divided by the sum.

As shown in FIG. 6B, new section lines 54 are drawn through each representative point 53A. The portion of boundary 15 lying in the segment 32 can then be approximated by a piecewise curve comprising a set of straight line segments 55 joining representative boundary points 53A and black and white points 18 and 19.

In some embodiments, positions of section lines 50 are subjected to optimization to improve the fit of the piecewise curve to the portion of the gamut boundary in the segment. This may be done once to reduce ongoing computational burden.

In such embodiments, boundary 15 can be represented with a relatively small amount of data. For example, FIG. 7 illustrates a data structure 60 representing a boundary 15. Data structure 60 comprises a table 62 corresponding to each segment 32. Each table 62 comprises a record 63 for each section line. Each record 63 comprises sufficient information to specify the section line. For example, in the illustrated embodiment, each record 63 stores a gradient 63A and intersection point 63B indicating where the section line intersects axis 11. In the illustrated embodiment, data structure 60 comprises an additional table 64 for each segment 32. Table 64 comprises a record 65 for each section of the segment. In the illustrated embodiment, record 65 contains data indicating the start boundary point 65A, end boundary point 65B and section line intersection point 65C for each section. Section line intersection point 65C specifies a point at which the section line intersects with an adjoining section line.

Data structure 60 may be a compact representation of boundary 15. For example, for the case where gamut 14 is divided into 60 segments each having 64 sections, and a 16 entry table may be used to determine point mappings and data structure 60 may contain 32523 values. Each value may, for example, comprise a 32-bit floating point value.

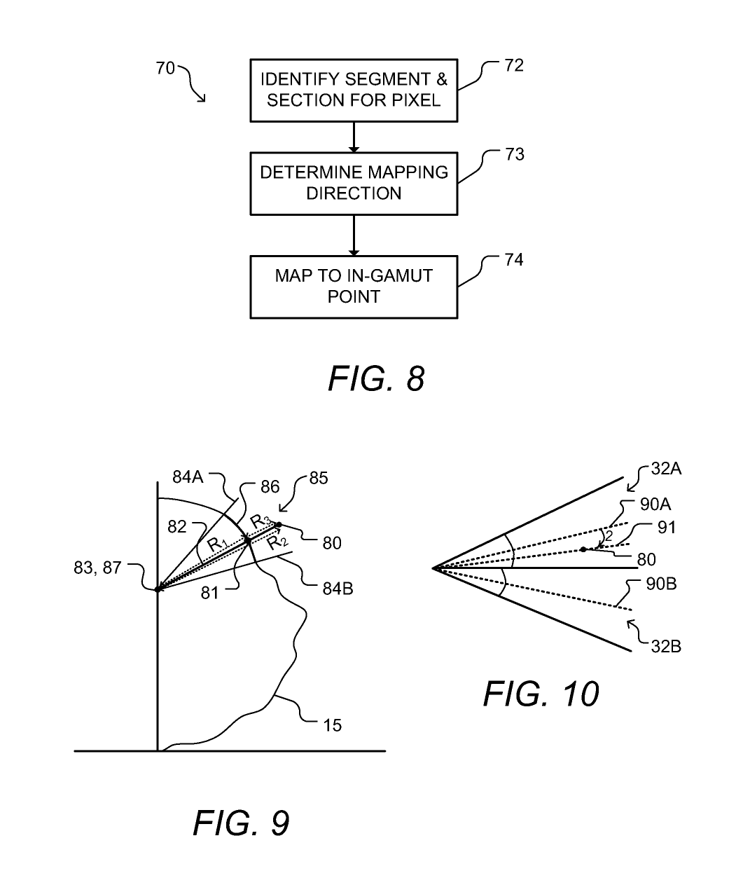

FIG. 8 illustrates a mapping method 70 for mapping out-of-gamut points to in-gamut points. Method 70 comprises a block 72 which determines which section of which segment each out-of-pixel point belongs to. At block 73, method 70 determines a mapping direction for the out-of-gamut pixel. At block 74, method 70 maps the out-of-gamut point to an in-gamut point.

FIG. 9 illustrates one approach that may be applied in block 74 of FIG. 8. For each out-of gamut point 80, a corresponding boundary intercept point 81 on gamut boundary 15 is identified. Boundary intercept point is on a line 82 between the out-of-gamut point 80 and the intersection point 83 of the section lines 84A and 84B that demarcate the section 85 in which out-of-gamut point 80 is located. The point of intersection 81 between line 82 and line segment 86 that constitutes the portion of gamut boundary 15 that lies in section 85 may be determined using any suitable line intersection algorithm (embodied in hardware or software depending on the implementation).

Once boundary intercept point 81 has been identified then boundary intercept point 81 may be used to establish a measure of how far out-of-gamut point 80 is. For example, a distance R1 between boundary intercept point 81 and axis intercept point 87 may be determined and a distance R3 between boundary intercept point 81 and out-of-gamut point 80 may be determined. In this case, the ratio R3/R1 provides an example measure of how far out-of-gamut point 80 is. In another example embodiment a distance R2 between the point 80 and axis intercept point 87 is determined. In this case the measure may be given by R2/R1 which has a value larger than one for out-of-gamut points.

In such embodiments, line 82 may provide a mapping direction and point 80 may be mapped to a point that is in-gamut and has a location along line 82 that is some function of the measure (e.g. a function of R3/R1 or R2/R1). In some embodiments, the function takes as a parameter how far out-of-gamut is a farthest out-of-gamut point either in the image being processed or, in some embodiments, in a set of images being processed (for example, in a set of two or more video frames).

In some embodiments, out-of gamut points for which the measure is below a threshold are mapped into an interior region of gamut 14 whereas out-of-gamut points for which the measure equals or exceeds the threshold may be clipped to boundary 15 (e.g. a point 80 may be clipped to boundary 15 by mapping the point 80 to boundary intersection point 81). The threshold applied to determine whether or not to clip a point 80 to boundary 15 may be fixed or determined based somehow on the current image data or image data for one or more related images (where the image being processed is a frame of a video sequence, the related images may comprise, for example, adjacent or nearby frames in the video sequence).

For example, methods and apparatus according to some embodiments acquire statistics regarding the number of out-of-gamut points and the measures of how far out-of-gamut the points are. Such statistics may be acquired for the image being processed and/or for related images. In some embodiments, a threshold is set equal to or based on one or more of:
a measure of how far out-of-gamut is a farthest out-of-gamut point in a related image;
a measure of how far out-of-gamut is a median, average, or mean out-of-gamut point in the image being processed and/or a related image;
a measure of how far out-of-gamut is a Nth percentile out-of-gamut point in the image being processed and/or a related image;
a measure of how far out-of-gamut is a farthest out-of-gamut point in the image being processed;
etc.

In a specific example embodiment, a threshold is set equal to the measure of a most out-of-gamut point from a previous frame or group of frames. For example where the measure is given by R2/R1 and the value of the measure is X then the threshold may be set to X such that points for which the measure has a value M in the range of 1<M X are mapped to a region within gamut 14 while points for which the measure has a value M>X are clipped to boundary 15. In another specific example embodiment a mapping function is selected so that the farthest out-of gamut point is mapped to boundary 15 and all other out-of-gamut points are mapped to a region within gamut 15. In another specific example embodiment a mapping function is selected so that out-of gamut points for which the measure equals or exceeds that of a certain percentile of the points from a related image are mapped to boundary 15 and all other out-of-gamut points are mapped to a region within gamut 15.

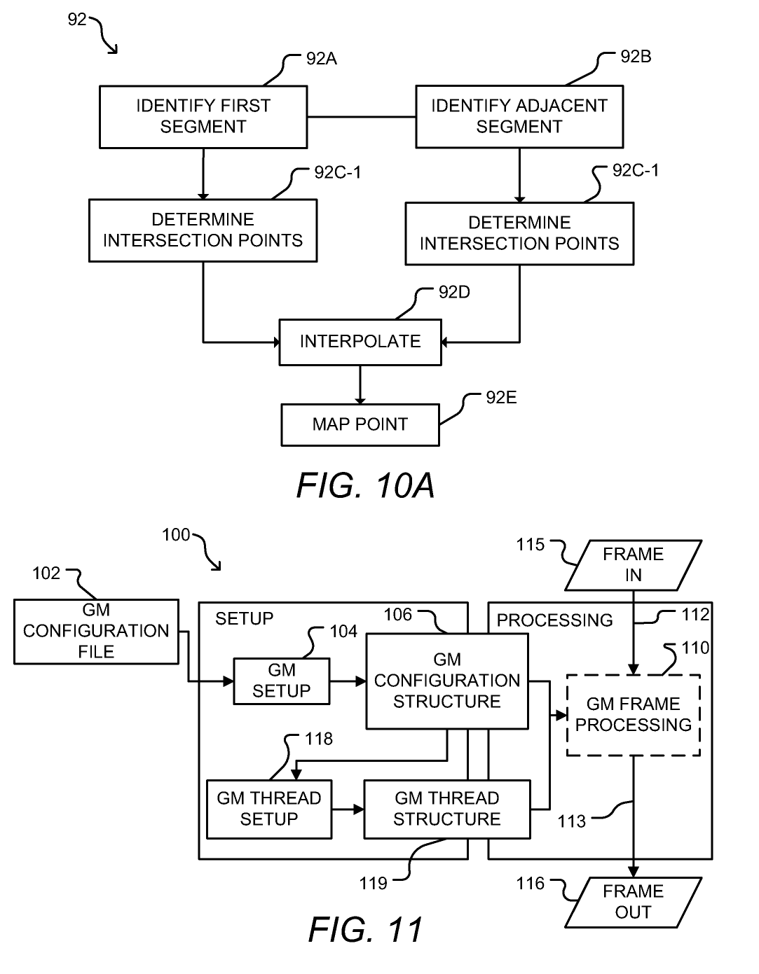

The number of segments 32 affects the potential error introduced by assuming that boundary 15 is the same for points of all hues falling within each segment 32. In some embodiments interpolation is performed between segments 52. This is illustrated in FIG. 10 which shows a latitudinal plane through gamut 14. An out of gamut point 80 is shown in a segment 32A. Lines 90 are shown which bisect segments 32. Point 80 lies on a line 91 at a polar angle è from line 90A toward line 90B. In this embodiment, a boundary intersection point 81 corresponding to point 80 is determined based on the approximation of boundary 15 specified for each of segments 32A and 32B. Interpolation is performed between the resulting points to determine a boundary intersection point to be used in mapping point 80 into gamut 14.

In some embodiments distances (e.g. R1, R2 and/or R3) suitable for computing a measure of how far point 80 is out of gamut are determined for each of segments 32A and 32B and the resulting measures are interpolated between to establish a measure of the degree to which point 80 is out-of-gamut. The resulting measure and boundary intersection point 81C may be applied in mapping the point 80 to a corresponding point in gamut 14. Interpolation may be based on the relative sizes of the angles between line 91 and lines 90A and 90B. The interpolation may comprise linear interpolation or, in alternative embodiments higher-order interpolation based upon multiple known boundary values.

FIG. 10A is a flow chart illustrating a method 92 which applies interpolation between distances determined for two adjacent segments to establish a mapping for a point. Block 92A identifies a first segment to which the point belongs. Block 92B identifies a second segment adjacent to the first segment to which the point being mapped is closest. In blocks 92C-1 and 92C-2, the axis intersection points and distances to boundary 15 for the point being mapped are determined for the first and second segments respectively. In block 92D, the values determined in blocks 92C-1 and 92C-2 are interpolated between (using the angular position of the point being mapped between centers of the first and second segments). In block 92E, the point is mapped to a new location on a line passing through the point and axis 11 using the interpolated values from block 92D.

Certain of the methods described above are advantageous in that they are well adapted to efficient implementations. FIG. 11 shows an example gamut compression apparatus 100. Apparatus 100 comprises a configuration file 102 comprising a memory containing configuration data. When apparatus 100 is initiated, a setup module 104 reads configuration file 102 and builds a number of lookup tables based on the configuration data. The lookup tables are hosted in a configuration structure 106. Configuration structure 106 may, for example, comprise a FPGA, a set of registers, a set of memory locations or the like.

Processing logic 110 is located in a data path between an input 112 and an output 113. Processing logic 110 performs mapping of values in input image data 115 to yield output image data 116. The mapping is determined by configuration structure 106. Since mapping of pixel values may be performed independently for different pixels, in some embodiments mapping of values for several pixels is performed in parallel. In some embodiments, processing logic 110 is implemented by way of a software process executing on a data processor. Some such embodiments provide multi-threaded software in which mapping for a plurality of pixels is performed in a corresponding plurality of concurrently-executing threads. In the illustrated embodiment a thread setup block 118 initiates threads and a thread data structure 119 maintains information regarding executing threads. In some embodiments, each frame of a video is processed by a thread or a set of threads. In other embodiments parallel mapping for a plurality of pixels is performed in parallel logic pipelines and processing logic 110 may incorporate a selection mechanism to direct incoming pixel values into available logic pipelines.

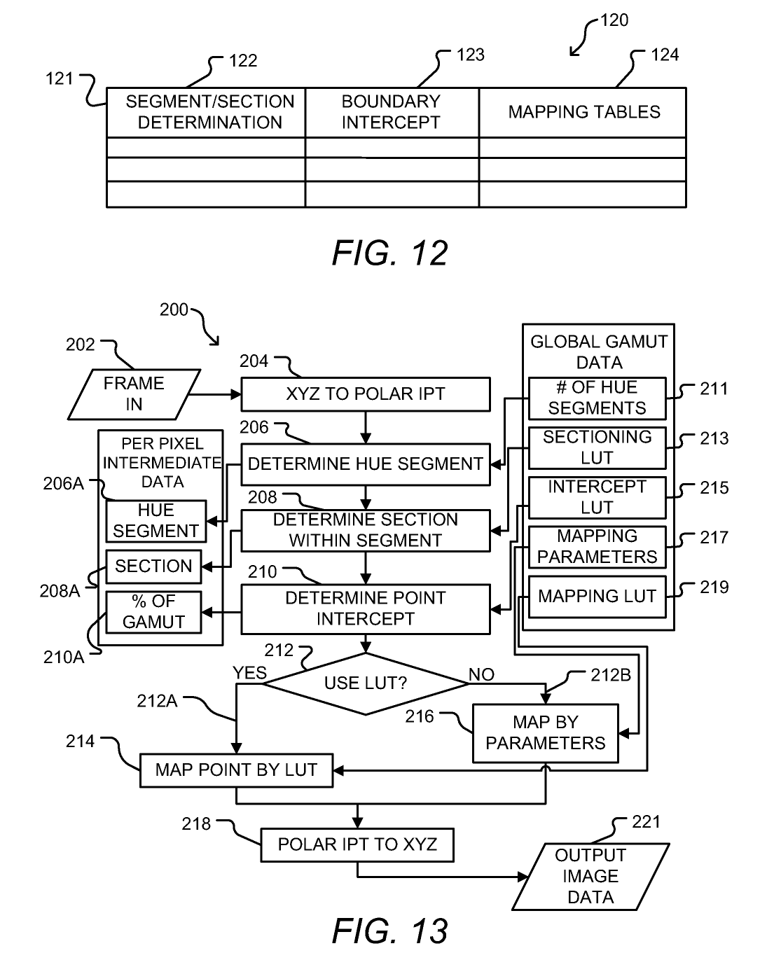

FIG. 12 shows a possible set of configuration information 120 for use in gamut mapping according to some example embodiments. Configuration information 120 includes a table 121 containing general configuration information. In an example embodiment, the general configuration information comprises values specifying: a number of segments; a number of sections into which each segment is divided; and a length of pixel mapping tables. It can be convenient to specify the number of segments as the inverse of the number of segments since some efficient algorithms can use the inverse of the number of segments to determine which segments individual points should be assigned to. In some embodiments general configuration information table 121 contains 3 items of data.

A set of segment/section determination tables 122 store information specifying boundaries of sections within segments. The boundaries may comprise section lines, for example. The information may specify, for example, boundary intercept and gradient for each section line for each segment. Where there are HS segments and NS sections per segment then, in some embodiments, segment/section determination tables 122 comprise HS(2NS-2) items of data.

A set of boundary intercept determination tables 123 stores information useful for determining a boundary intercept toward which out-of-gamut points may be mapped and/or determining a direction in which in-gamut points may be compressed. In an example embodiment, boundary intercept determination tables 123 store three 2D coordinate sets for each section of each segment. The coordinate sets may, for example, specify a start point, end point and edge cross-section (e.g. section line intersection point 65) for each section. This is illustrated, for example in FIG. 7. In some embodiments, tables 123 comprise HS(6SN) items of data.

A set of pixel mapping tables 124 specify mappings for points. Pixel mapping tables 124 may, for example, specify input and output percentages of gamut. In some embodiments, pixel mapping tables comprise HS(2TL) items of data where TL is a number of entries in each table. Table I shows an example pixel mapping table.

TABLE I
Example Pixel-mapping Lookup Table

| Input | 0 | 0.85 | 0.92 | 1 | 1.2 | 1.3 | 1.4 | 2 |
|---|---|---|---|---|---|---|---|---|
| Output | 0 | 0.85 | 0.9 | 0.93 | 0.98 | 0.99 | 1 | 1 |

Some embodiments adaptively modify pixel mapping tables such as that shown in Table 1 to take into account how far out-of-gamut any out-of-gamut points tend to be. Such modifications may be made to the input values in a lookup table. For example, suppose that statistics for one or more previous frames of data indicate that the farthest out-of-gamut points are out-of-gamut by 150% of the target gamut (i.e. input values do not exceed 1.5). The lookup table of Table I could be modified as illustrated in Table II.

TABLE II
Example Modified Pixel-mapping Lookup Table

| Input | 0 | 0.85 | 0.92 | 1 | 1.1 | 1.15 | 1.25 | 1.5 |
|---|---|---|---|---|---|---|---|---|
| Output | 0 | 0.85 | 0.9 | 0.93 | 0.98 | 0.99 | 1 | 1 |

In some embodiments, such adaptive modifications to the lookup tables affect only input values corresponding to out-of-gamut pixels (e.g. input values above 1.0 in the examples of Tables I and II).

FIG. 13 is a flow chart illustrating a method 200 that may be applied to real-time gamut mapping of image data (which is video data in some embodiments). Method 200 receives a frame 202 of image data. In the illustrated embodiment, pixel values in frame 202 define points expressed in an XYZ color space. Block 204 performs a transformation of the data of frame 202 to a polar color space such as polar IPT or CIE LAB.

Blocks 206 through 216 are performed for each pixel in the transformed data. Block 206 identifies a segment 206A in which a color point for the pixel is located. Block 206 uses data 211 defining the segments (e.g. data specifying how many segments there are) in block 206. In some embodiments block 206 comprises multiplying a polar hue value by an inverse of the range of hue values divided by the number of segments. For example, a segment 206A for a point may be identified by computing:

$$Seg = θ \times ( \frac{NS}{360} ) \qquad ( 1 )$$

where: the integer part of Seg is a value identifying the segment, θ is a polar hue value (in degrees), NS is the number of segments and 360 is the range of hue values.

In other embodiments a lookup table is consulted to identify which segment a point belongs to. It is not mandatory that segments each be the same size or that the segments be regular. A lookup table is a convenient way to identify a segment corresponding to a point where the segments are irregular.

Block 208 identifies a section 208A of the segment to which the color point belongs. Block 208 may use a sectioning lookup table 213 to determine which section 208A the point belongs to. In some embodiments block 208 determines a gradient (slope) of a line joining the color point being mapped to a point on axis 11 intersected by a section boundary. A comparison of this gradient to a gradient of the section boundary indicates whether the color point is above (i.e. in a greater luminance direction) or below the section boundary.

In some embodiments, this is iterated for different section boundaries to narrow down the location of the color point to one section. For example, a binary search may be conducted. Where there are an even number of sections, then block 208 may perform a gradient comparison to determine whether the color point is in a first portion of the segment above a central section boundary in the segment or in a second portion of the segment below the central section boundary. This can then be repeated by performing a gradient comparison to determine whether the color point is above or below a central section boundary to the first or second portion of the segment as the case may be. This may be continued until the section in which the color point is located has been determined. Where there are 2ⁿ sections (i.e. SN=2ⁿ) then the section in which the color point is located can be identified by performing n gradient comparisons.

Other options are also possible. For example, an apparatus may be configured to determine intersections of section lines with a line passing through the color point parallel to axis 11. The section 208A to which the color point belongs may be identified by comparing the magnitude of the luminance values for the intersection point to the luminance value for the color point.

Block 210 determines the mapping trajectory's intercept with the gamut boundary; the intercept may be determined by locating the intersection between the gamut boundary 15 and the line that runs between the point being mapped and the previously calculated section edges' intersection point. The mapping trajectory's intersection point with axis 11 and distance to both the point being mapped and gamut boundary 15 may also be determined (e.g. a measure 210A of how far out-of-gamut the point is). The intercept at block 210 may be determined by an intercept lookup table 215.

Block 212 determines how the point will be mapped. In the case of result 212A, method 200 proceeds to block 214 which maps the point to a point translated in the mapping direction by a distance determined by a mapping lookup table 219. In the case of result 212B, method 200 proceeds to block 216 which performs a mapping according to mapping parameters 217. In some embodiments the decision in block 212 is based on coordinates of a point to be mapped.

The mapping parameters may, for example identify one of a plurality of predefined rules for mapping points. The mapping parameters may also include additional inputs which control aspects of the operation of a selected rule. For example, mapping parameters may identify a rule selected from:
1. A rule that clips out of gamut points to the gamut boundary (or a clipping boundary within the gamut boundary).
2. A rule that scales all points by the same amount so that all points are within the gamut after scaling.
3. A rule that scales all points by some amount and then clips out-of gamut scaled points to the gamut boundary.
4. A rule that scales by a variable scaling (knee function) depending upon how close points are to being out of gamut (or how far out of gamut the points are).
5. A rule that applies a look up table to determine mappings for points (there may be a plurality of such rules that apply different look up tables to be selected among).

The mapping parameters may include values that specify the behaviour of a selected rule. For example, where a rule has been selected that scales out-of-gamut pixels inwardly, a parameter may determine what feature(s) pixels are mapped towards. Such a parameter may, for example, control a selection between mapping toward:

1. A global center.
2. A hue cusp.
3. A constant lightness.
The parameters may also specify values controlling things such as:

The coordinates of a global center.

An amount, if any, that a clipping boundary lies inside of the gamut boundary.

A scaling factor.

A point outside of which pixels are scaled (or a scaling changes).

etc.

In some embodiments separate mapping parameters are provided for points above and below a cusp in the gamut boundary.

Block 218 transforms the mapped data points back to an XYZ color space to yield output image data 221.

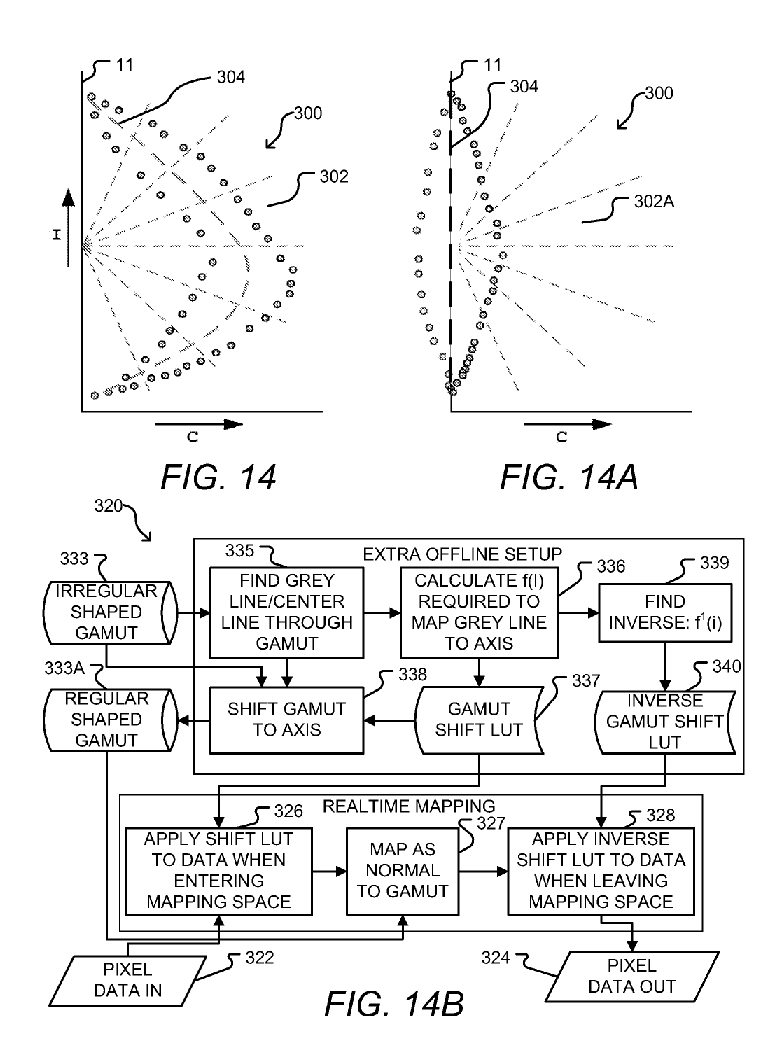

Some target devices or media may support gamuts in which the transformation of the gamut into the color space in which mapping is performed results in a grey line that is curved. This is illustrated in FIG. 14 showing a cross section in color space 300 of a gamut 302 in which grey line 304 is both curved and translated relative to axis 11 of the color space 300.

Such situations may be addressed by making a transformation in color space 300 between gamut 302 and a transformed version of gamut 302 in which the grey line 304 is aligned with axis 11. This is illustrated in FIG. 14A which shows a transformed version 302A of gamut 302. Mapping may be performed using transformed version 302A and an inverse transformation may be performed prior to outputting transformed image data.

FIG. 14B illustrates a data flow for the case where such additional transformations are performed to accommodate an irregular gamut. Mapping is performed in a logic pipeline 320 which may be implemented in hardware and/or software. Input pixel data 322 is processed in logic pipeline 302 to yield output pixel data 324. Logic pipeline 320 includes a first transformation 326 that has been determined to map the target gamut so that grey line 304 is aligned with axis 11. A mapping block 327 performs gamut mapping in the manner described herein. An inverse transformation block 328 applies an inverse of the translation performed by first transformation 326 to yield output pixel data 324.

Logic pipeline is supported by configuration data 330. Target gamut data 333 defining a target gamut is processed in block 335 to identify a grey line 304. In some embodiments the grey line is identified by determining a center of mass of all or selected boundary points for each luminance level. In some embodiments a grey line may be specified by parameters accompanying or forming part of the gamut data. A transformation to bring grey line 304 coincident with axis 11 is determined in block 336. Block 336 provides data defining the transformation. For example, block 336 may provide output in the form of one or more lookup tables 337 which defines the transformation. Block 338 applies the transformation specified by lookup tables 337 to target gamut data 333 to yield a regularized version of the target gamut defined by regularized target gamut 333A. Regularized target gamut is applied as the target gamut by mapping block 326.

Block 339 determines an inverse of the transformation represented by lookup tables 337. Block 339 provides data 340 defining the inverse transformation. For example, block 339 may provide output in the form of one or more lookup tables 340 which define the inverse transformation. Lookup tables 340 are applied by block 328.

Gamut mapping as described herein may be applied to digital images such as photographs, computer-generated images, video images, or the like.

In some embodiments, image data is available in a format native to a target display (such as RGB) from which it can be easy to determine whether or not a point is out-of-gamut for the target display. For example, coordinates for each of R, G and B can be individually compared to ranges that the target device is capable of reproducing. A point may be determined to be out-of-gamut if any of the coordinates is outside the range reachable by the target device. As noted above, gamut mapping according to methods as described herein is facilitated by operating in a color space in which points are specified by cylindrical coordinates with constant hue for constant value of a coordinate e indicating angle about an axis. In some embodiments, image data is received in a native color space such as RGB and out-of-gamut pixels are identified in the RGB color space. The image data is transformed into a color space more convenient for performing a gamut transformation and the previously-identified out-of-gamut points are transformed (for example onto gamut boundary 15). In-gamut points may be ignored by the gamut translation such that their values are unaltered.

It can be appreciated that embodiments as described herein may be implemented in ways that do not require buffering of significant (or any) amounts of image data. Gamut compression may be performed on a pixel-by-pixel basis without reference to the transformations applied to other pixels. Where the image data is video data, statistics regarding out-of-gamut pixels may be accumulated as video frames are processed and these statistics applied to gamut compression of future video frames. Embodiments as described herein may be implemented in ways that replace computationally intensive processes with look up operations performed in look up tables.

Gamut transformation methods and apparatus, as described herein may be configured in a wide range of ways which differ in the points in a target gamut to which points in a source gamut are mapped. In embodiments in which it is desired to preserve a creative intent expressed in an original image and/or to provide transformed images which appear closely similar to original images it is generally desirable that a gamut transformation possesses one or more of, and preferably all of, the following properties:
Minimization of color differences between the source and transformed images (so as to most closely approach colors present in the source image within the capability of the target device or medium);
Preservation of differences between colors (i.e. if colors can be distinguished in the source image then the corresponding colors in the transformed image should also be distinguishable).
   It is also desirable that a transformation be adaptable to translate from a wide range of source gamuts to gamuts of a wide range of target devices and/or media. Advantageously, gamut and/or tone transformations as described herein may be embodied in ways that closely approach these properties.

It can be appreciated that the invention may be applied in a wide range of contexts. For example, some embodiments provide displays or image processing apparatus used upstream from displays which implement methods or apparatus for gamut transformation as described herein. In some embodiments a video or image source such as a media player, video server, computer game, virtual reality source, camera, or the like implements methods or apparatus as described herein to adapt image data (which may comprise video data and/or still image data) for display on a particular display or type of display. These example implementations are not intended to be limiting.

The above description and accompanying drawings illustrate a number of non-limiting example embodiments of the invention. Features of the example embodiments may be combined in ways other than those expressly set out herein to provide further example embodiments.

Certain implementations of the invention comprise computer processors which execute software instructions which cause the processors to perform a method of the invention. For example, one or more processors in an image processing device such as a display may implement the methods of FIGS. 2, 8, 10A,11, 13, 14B and 15 by executing software instructions in a program memory accessible to the processors. The invention may also be provided in the form of a program product. The program product may comprise any medium which carries a set of computer-readable signals comprising instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

Accordingly, the invention may be embodied in any of the forms described herein, including, but not limited to the following Enumerated Example Embodiments (EEEs) which describe structure, features, and functionality of some portions of the present invention:
EEE1. A method for gamut mapping, the method comprising:
   a) identifying points in image data that are out-of-gamut for a target gamut;
   b) for the out-of-gamut points, identifying a surface of constant hue on which the point is located;
      identifying one of a plurality of sections on the surface in which the point is located;
      selecting a mapping algorithm corresponding to the section in which the point is located;
      applying the selected mapping algorithm to transform the out-of-gamut point to a corresponding in-gamut point.
EEE2. A method according to EEE 1 comprising locating a cusp in a portion of a boundary of the gamut lying in the surface of constant hue, applying a first mapping algorithm for mapping points having lightness greater than that of the cusp and applying a second mapping algorithm for mapping points having lightness below that of the cusp.
EEE3. A method according to EEE 2 comprising applying a constant-luminance mapping for points having lightness lower than the lightness of the cusp.
EEE4. A method according to EEE 2 or 3 comprising applying a mapping that takes points toward a fixed point for points having lightness greater than the lightness of the cusp.
EEE5. A method according to any one of EEEs 1 to 4 wherein the target gamut comprises a nonlinear grey line and the method comprises;
   providing a transformation that transforms the target gamut into a transformed target gamut in which the grey line is linear and aligned with an axis of a color space and applying the transformation to the image data before identifying the points in the image data that are out-of-gamut; and
   applying an inverse of the transformation to the image data after applying the selected mapping algorithm to transform the out-of-gamut point.
EEE6. A method according to EEE 5 wherein applying the transformation to the target gamut comprises mapping a black point of the target gamut to a different point.
EEE7. A method according to EEE 1 performed in a color-opponent color space.
EEE8. A method according to EEE 7 wherein the color space comprises the IPT or CIE LAB color space.
EEE9. A method for gamut mapping, the method comprising:
   a) identifying points in image data that are out-of-gamut for a target gamut;
   b) for an out-of-gamut point,
      determining whether the point is above or below a surface defined in part by a cusp in a boundary of the gamut at a hue corresponding to the point;
      selecting a first mapping algorithm if the point is above the surface;
      selecting a second mapping algorithm if the point is below the surface;
      applying the selected mapping algorithm to transform the out-of-gamut point to a corresponding in-gamut point.
EEE10. A method according to EEE 9 wherein the second mapping algorithm comprises a constant lightness transformation.
EEE11. A method according to EEE 10 wherein the second mapping algorithm clips the out-of-gamut point to the gamut boundary.
EEE12. A method according to EEE 10 wherein the first mapping algorithm maps the out-of-gamut point toward a fixed point.
EEE13. A method according to EEE 12 wherein the fixed point comprises a fixed point on a lightness axis.
EEE14. A method according to EEE 13 wherein the fixed point is half-way between a white point and a black point on the lightness axis.
EEE15. A method according to EEE 13 wherein the fixed point has a lightness value equal to a lightness value of the cusp.
EEE16. A method according to EEE 12 wherein the fixed point is on a far side of the lightness axis from the out-of-gamut point.
EEE17. A method according to EEE 10 wherein the first mapping algorithm maps the out-of-gamut point to a point on the gamut boundary that is closest to the out-of-gamut point.
EEE18. A method according to EEE 10 comprising mapping points lying within the gamut in a layer adjacent to the gamut boundary inwardly.
EEE19. A method according to EEE 18 wherein the layer is variable in thickness.
EEE20. A method according to EEE 19 wherein the layer tapers to zero at black and white points.
EEE21. A method according to EEE 10 wherein the first mapping algorithm comprises mapping out-of-gamut points into a region that is interior to and adjacent the gamut boundary and compressing in-gamut points within the region inwardly.
EEE22. A method according to EEE 10 wherein the first mapping algorithm comprises determining a mapping trajectory for the out-of-gamut point and mapping the out-of-gamut point to a corresponding point along the mapping trajectory that is determined based at least in part on a measure of how far out-of-gamut the out-of-gamut point is.
EEE23. A method according to EEE 10 comprising mapping points having a lightness value below a lightness value of the cusp to the gamut boundary and mapping points having a lightness value above the lightness value of the cusp into the gamut using an algorithm that provides compression of some points in the gamut.
EEE24. A method for gamut mapping, the method comprising:

a) identifying points in image data that are out-of-gamut for a target gamut;

b) for an out-of-gamut point,
identifying one of a plurality of in to which the out-of-gamut point is located, each segment bounded by planes that intersect on a lightness axis of the gamut;
identifying one of a plurality of sections of the segment in which the out-of-gamut point is located;
   identifying one of a plurality of available mapping algorithms that corresponds to the segment and section in which the out-of-gamut point is located; and,
applying the identified mapping algorithm to map the out-of-gamut point to a corresponding in-gamut point.
EEE25. A method for gamut mapping, the method comprising: mapping out-of-gamut points having a lightness value below a threshold lightness value to a boundary of a gamut and mapping out-of-gamut points having a lightness value above the threshold lightness value into the gamut using an algorithm that provides compression of at least some points within the gamut.
EEE26. A method according to EEE 25 wherein the method provides compression of points within a layer adjacent to the gamut boundary wherein the layer tapers to zero thickness at the threshold lightness value.
EEE27. A gamut mapping method comprising determining whether a point is out-of-gamut by comparing coordinates of the point to a reduced data set defining a gamut boundary wherein the reduced data set represents the gamut as a plurality of wedge-shaped segments each defined between a pair of planes that intersect along a lightness axis of the gamut and a piecewise boundary for each of the segments.
EEE28. A method according to EEE 27 wherein the piecewise boundary is a piecewise linear boundary.
EEE29. A method according to EEE 27 wherein the gamut is divided into 30 to 720 segments.
EEE30. A method according to EEE 27 comprising determining distances between an out-of-gamut point and the gamut boundary for two adjacent segments and interpolating to establish an interpolated distance between the out-of-gamut point and the gamut boundary.
EEE31. Apparatus comprising:
   a comparison unit configured to identify a point that is out-of-gamut relative to a gamut boundary;
   a selection unit configured to select one of a plurality of mapping algorithms based on one or more coordinate values for the out-of-gamut point; and
      a mapping unit configured to apply the mapping algorithm selected by the selection unit to map the out-of-gamut point to a corresponding in-gamut point

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1-16. (canceled)

17. A method for gamut mapping, the method comprising:
a) identifying points in image data that are out-of-gamut for a target gamut;
b) for the out-of-gamut points,
identifying a surface of constant hue on which the point is located;
identifying one of a plurality of sections on the surface in which the point is located;
selecting a mapping algorithm corresponding to the section in which the point is located;
applying the selected mapping algorithm to transform the out-of-gamut point to a corresponding in-gamut point.

18. A method according to claim 17 comprising locating a cusp in a portion of a boundary of the gamut lying in the surface of constant hue, applying a first mapping algorithm for mapping points having lightness greater than that of the cusp and applying a second mapping algorithm for mapping points having lightness below that of the cusp.

19. A method according to claim 18 comprising applying a constant-luminance mapping for points having lightness lower than the lightness of the cusp.

20. A method according to claim 18 comprising applying a mapping that takes points toward a fixed point for points having lightness greater than the lightness of the cusp.

21. A method according to claim 17 wherein the target gamut comprises a nonlinear grey line and the method comprises;
providing a transformation that transforms the target gamut into a transformed target gamut in which the grey line is linear and aligned with an axis of a color space and applying the transformation to the image data before identifying the points in the image data that are out-of-gamut; and
applying an inverse of the transformation to the image data after applying the selected mapping algorithm to transform the out-of-gamut point.

22. A method according to claim 21 wherein applying the transformation to the target gamut comprises mapping a black point of the target gamut to a different point.

23. A method according to claim 17 performed in a color-opponent color space.

24. A method according to claim 23 wherein the color space comprises the IPT or CIE LAB color space.

25. A method for gamut mapping, the method comprising:
a) identifying points in image data that are out-of-gamut for a target gamut;
b) for an out-of-gamut point,
determining whether the point is above or below a surface defined in part by a cusp in a boundary of the gamut at a hue corresponding to the point;
selecting a first mapping algorithm if the point is above the surface;
selecting a second mapping algorithm if the point is below the surface;
applying the selected mapping algorithm to transform the out-of-gamut point to a corresponding in-gamut point.

26. A method according to claim 25 wherein the second mapping algorithm comprises a constant lightness transformation.

27. A method according to claim 26 wherein the second mapping algorithm clips the out-of-gamut point to the gamut boundary.

28. A method according to claim 26 wherein the first mapping algorithm maps the out-of-gamut point toward a fixed point.

29. A method according to claim 28 wherein the fixed point comprises a fixed point on a lightness axis.

30. A method for gamut mapping, the method comprising:
a) identifying points in image data that are out-of-gamut for a target gamut;
b) for an out-of-gamut point,
identifying one of a plurality of in to which the out-of-gamut point is located, each segment bounded by planes that intersect on a lightness axis of the gamut;
identifying one of a plurality of sections of the segment in which the out-of-gamut point is located;
identifying one of a plurality of available mapping algorithms that corresponds to the segment and section in which the out-of-gamut point is located; and,
applying the identified mapping algorithm to map the out-of-gamut point to a corresponding in-gamut point.

31. A gamut mapping method comprising determining whether a point is out-of-gamut by comparing coordinates of the point to a reduced data set defining a gamut boundary wherein the reduced data set represents the gamut as a plurality of wedge-shaped segments each defined between a pair of planes that intersect along a lightness axis of the gamut and a piecewise boundary for each of the segments.

32. Apparatus comprising:
a comparison unit configured to identify a point that is out-of-gamut relative to a gamut boundary;
a selection unit configured to select one of a plurality of mapping algorithms based on one or more coordinate values for the out-of-gamut point; and
a mapping unit configured to apply the mapping algorithm selected by the selection unit to map the out-of-gamut point to a corresponding in-gamut point.
